(19) United States
(12) Patent Application Publication
(10) Pub. No.: US 2011/0136623 A1
(43) Pub. Date: Jun. 9, 2011

(54) METHOD FOR POSITIONING AN ENGINE

(76) Inventor: Janko Bosnjak, Beilstein (DE)

(21) Appl. No.: 12/959,554

(22) Filed: Dec. 3, 2010

(30) Foreign Application Priority Data
Dec. 8, 2009 (DE) 102009047642.3

(51) Int. Cl. B60W 30/00; B60W 10/02; B60W 10/06

(52) U.S. Cl. 477/174

(57) ABSTRACT

A method for positioning an engine, a clutch of a transmission of the engine being activated in a targeted manner and engaged in a controlled manner during the deceleration process of the engine. Also, a system for positioning an engine.

### FIELD OF THE INVENTION

The present invention relates to a method and a system for positioning an engine.

### BACKGROUND INFORMATION

The operation of an engine for a vehicle is influenced by different operating parameters which interact with one another if necessary. It is provided, for example, that during a deceleration process of the engine, its rotational speed is reduced as an operating parameter. During a deceleration process, the engine is normally influenced by a generator interacting with the engine and/or a degree of opening of a throttle valve of the engine.

### SUMMARY OF THE INVENTION

Among other things, the present invention relates to a method for positioning an engine designed as an internal combustion engine for a vehicle, the clutch or the transmission being actively activated for influencing engine operation.

In connection with the present invention, it is provided that during the deceleration process of the engine, the clutch of the transmission is activated automatically in a targeted manner to shorten the deceleration process in this way. As a result, this eliminates a delay until the engine is restarted.

The more rapid deceleration makes it possible to use a simpler and more economical starter, for example in a start-stop system or a corresponding automatic system, for example the starter SSM1 instead of the starter SSM2 or SSM3 from Robert Bosch GmbH.

The method normally makes it possible to shorten the time until the engine comes to a standstill and to improve the behavior of an engine designed as an internal combustion engine during the deceleration process, so that the engine does not need to oscillate, for example, when a dual clutch transmission is used, typically in connection with start-stop systems.

After an engine stop request is made, the clutch of the dual clutch transmission is normally automatically engaged in a controlled manner below a threshold rotational speed. As a result, the engine reaches rotational speed n=0 more quickly.

In one embodiment of the present invention, the threshold rotational speed is defined in such a way that an independent run-up of the combustion engine, which may be initiated by injection and ignition, is possible above this threshold rotational speed. Independent run-up is not possible below this threshold rotational speed.

The clutch is engaged in a controlled manner below this threshold rotational speed. As a result, the combustion engine is decelerated, does not oscillate, and reaches its resting state more quickly. Since the driver has normally depressed the brake, the vehicle is not moved in this process.

The system according to the present invention is designed to carry out all steps of the described method. Individual steps of this method may also be carried out by individual components of the system. Furthermore, functions of the system or functions of individual components of the system may be implemented as steps of the method. In addition, it is possible that steps of the method may be implemented as functions of at least one component of the system or the entire system.

### BRIEF DESCRIPTION OF THE DRAWINGS

FIG. 1 shows a schematic representation of one diagram for a specific embodiment of the method according to the present invention.

FIG. 2 shows a schematic representation of one specific embodiment of the system according to the present invention.

### DETAILED DESCRIPTION

The present invention is depicted schematically in the drawings on the basis of specific embodiments and is described in greater detail below with reference to the drawings.

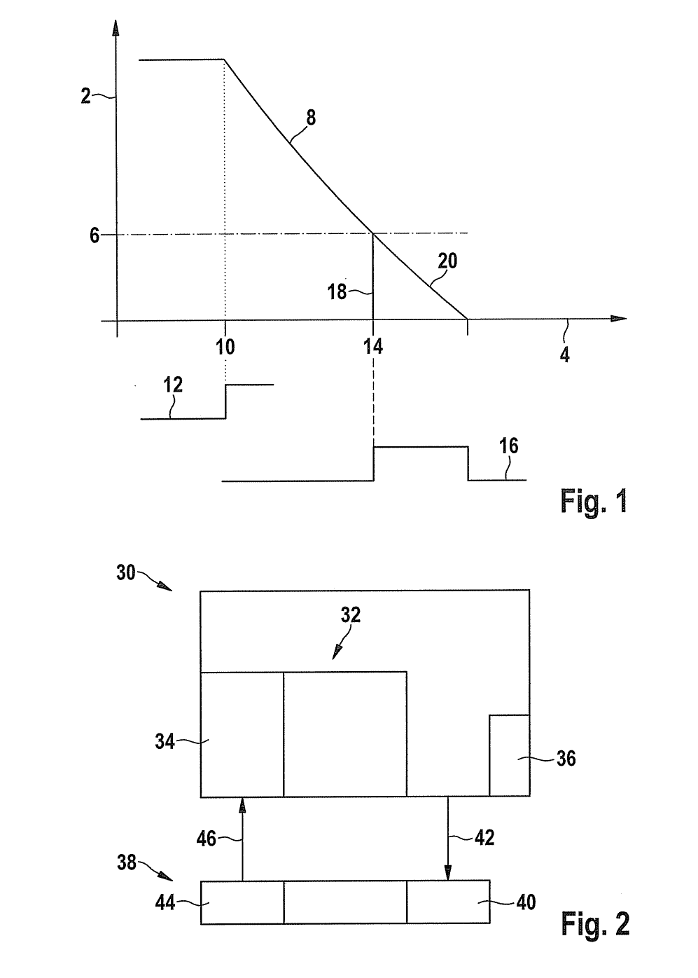

The diagram shown in FIG. 1 includes a vertically oriented axis 2, along which a rotational speed n of an engine is plotted across a horizontally oriented time axis 4. A threshold rotational speed 6 nₛ is entered in the diagram in the form of a dot-dash line. This threshold rotational speed 6 nₛ is defined in such a way that an independent run-up of the engine is possible if a curve of rotational speed 8 n is greater than threshold rotational speed 6 nₛ. If rotational speed 8 n is below threshold rotational speed 6 nₛ, such an independent run-up of the engine is no longer possible.

In the specific embodiment of the method according to the present invention described here, it is provided that a stop request 12 is made for the engine at a first point in time 10 t₁. As a consequence, rotational speed 8 n decreases until rotational speed 8 n reaches described threshold rotational speed 6 nₛ at a second point in time 14 t₂.

In connection with the method, it is now provided that the clutch of the transmission is actively activated in a targeted manner and is thus engaged in a controlled manner. An effect of this measure, which may be described as a deceleration 16 of the engine by the clutch, is documented in the diagram from FIG. 1 by a first branch 18 of a curve of rotational speed 8 n. As a result of deceleration 16 caused by the engagement of the clutch, rotational speed n of the engine decreases abruptly in a short time and reaches the value 0.

A second branch 20 of the curve of rotational speed 8 n shows the situation in the case of a conventional deceleration process of the engine in which it is not provided to engage the clutch.

FIG. 2 shows a schematic representation of an engine 30 having a transmission 32 including a clutch 34. In addition, engine 30 includes a so-called automatic start-stop system 36 which makes automatic start and stop of engine 30 possible. In addition, FIG. 2 shows a specific embodiment of a system 38 according to the present invention which includes a monitoring module 40 for detecting a rotational speed 42 of engine 30, system 38 including a control module 44 designed for automatically acting upon at least one component of engine 30, in this case clutch 34 of transmission 32.

In an implementation of the method according to the present invention, rotational speed 42 of engine 30 is monitored by monitoring module 40 during a deceleration process of engine 30. As soon as rotational speed 42 reaches and/or falls below a threshold rotational speed, clutch 34 is acted upon 46, clutch 34 being engaged automatically by control module 44.

The described specific embodiment of system 38 may be designed as a component of a control unit for engine 30. Although system 38 in FIG. 2 is schematically represented as a module outside of engine 30, system 38 may be also be designed as a component of the engine in one embodiment of the present invention.

What is claimed is:

1. A method for positioning an engine, comprising:
activating a clutch of a transmission of the engine in a targeted manner and engaging the clutch in a controlled manner during a deceleration process of the engine.

2. The method according to claim 1, wherein the method is implemented when the engine has reached a rotational speed below a threshold rotational speed during the deceleration process.

3. The method according to claim 2, wherein the threshold rotational speed is defined in such a way that an independent run-up of the engine is possible above the threshold rotational speed, while an independent run-up of the engine is not possible below the threshold rotational speed.

4. The method according to claim 1, wherein the method is implemented for an engine, the transmission being designed as a dual clutch transmission having a dual clutch as the clutch.

5. The method according to claim 1, wherein the method is implemented for an engine which interacts with an automatic start-stop system.

6. A system for positioning an engine, comprising:
a control module for acting upon a clutch of a transmission of the engine, the control module activating the clutch in a targeted manner and engaging the clutch in a controlled manner during a deceleration process of the engine.

7. The system according to claim 6, further comprising a monitoring module for monitoring a rotational speed of the engine.
